(19) United States
(12) Patent Application Publication
(10) Pub. No.: US 2019/0007412 A1
(43) Pub. Date: Jan. 3, 2019

(54) CUSTOMIZED DEVICE IDENTIFICATION

(71) Applicant: CA, Inc., New York, NY (US)

(72) Inventor: Jaimini Ram, Bangalore (IN)

(21) Appl. No.: 15/641,039

(22) Filed: Jul. 3, 2017

(51) Int. Cl. H04L 29/06; H04W 12/08; H04W 12/06

(52) U.S. Cl. CPC H04L 63/101; H04W 12/08; H04L 67/02; H04W 12/06; H04L 63/083

(57) ABSTRACT

Techniques are disclosed relating to an identification computer system using script-based identification techniques to identify a remote computer system. The identification computer system receives initial information from the remote computer system and, based on the received information, customizes a device identification procedure for the remote computer system to perform. The device identification procedure includes one or more scripts executable by the remote computer system to generate results that the remote computer system sends to the identification computer system. Based on the results, the identification computer system attempts to identify the remote computer system.

### BACKGROUND

### Technical Field

This disclosure relates generally to identification of a remote computer system that is communicating with a computer system.

### Description of the Related Art

One approach to identifying a remote computer system is for the identifying computer system to send one or more files (e.g., a “cookie”) to the user device during an initial contact with the remote computer system, and for the remote computer system to use the one or more files in subsequent communications with the identification computer system. The one or more files, for example, may contain cryptographic information (e.g., a public key of a public-private key pair) that the identifying computer system can use to determine that in subsequent communications the user device is the same user device with which initial contact was made.

In contrast to such “tagged identification”, script-based identification may be performed without the use of a cookie or another file with information usable for identification.

### SUMMARY

In an embodiment, a non-transitory, computer-readable medium stores instructions that, when executed by a computer system, cause the computer system to perform operations. Such operations comprise receiving, from a remote computer system that is running a program, information that specifies at least one characteristic of the remote computer system and at least one characteristic of the program. Operations further comprise determining a device identification procedure that is customized for the remote computer system based on the received information. The device identification procedure specifies one or more scripts executable by the remote computer system. Additionally, operations comprise sending, to the remote computer system, an indication of the device identification procedure; receiving, from the remote computer system, a set of results produced by execution of the one or more scripts by the remote computer system; and identifying, using the set of results, the remote computer system.

In another embodiment, a method comprises receiving, at a computer system and from a remote computer system, information indicating at least one characteristic of the remote computer system and at least one characteristic of a program running on the remote computer system. The method further comprises determining, with the computer system, a device identification procedure that is customized for the remote computer system based on the received information. The device identification procedure specifies one or more scripts executable by the remote computer system. The method also comprises sending, from the computer system to the remote computer system, an indication of the device identification procedure; receiving, at the computer system and from the remote computer system, a set of results produced by execution of the one or more scripts by the remote computer system; and identifying, at the computer system, the remote computer system using the set of results.

In still another embodiment, a method comprises sending, from a remote computer system to a computer system, information that specifies at least one characteristic of the remote computer system and at least one characteristic of a program running on the remote computer system. The method further comprises receiving, at the remote computer system from the computer system, an indication of a device identification procedure. The device identification procedure is customized for the remote computer system based on the sent information. The device identification procedure specifies one or more device identification scripts executable by the remote computer system. Additionally, the method comprises executing, at the remote computer system, the one or more device identification scripts and producing a set of results from executing the one or more device identification scripts; and sending, from the remote computer system to the computer system, the set of results.

### BRIEF DESCRIPTION OF THE DRAWINGS

FIG. 1 is a block diagram illustrating one embodiment of a computer system configured to authenticate a remote computer system.

FIG. 2A is an expanded block diagram of the remote computer system of FIG. 1.

FIG. 2B is an alternative, expanded block diagram of the remote computer system of FIG. 1.

FIG. 3 is an expanded block diagram of the identification computer system of FIG. 1.

FIG. 4 is a flowchart illustrating a remote computer system identification method in accordance with the disclosed embodiments.

FIG. 5 is flowchart illustrating a customized device identification method in accordance with the disclosed embodiments.

FIG. 6A is a flowchart illustrating a customized device identification (using a web browser) method in accordance with the disclosed embodiments.

FIG. 6B is a flowchart illustrating a customized device identification (using an application distinct from a web browser) method in accordance with the disclosed embodiments.

FIG. 7 is a flowchart illustrating various sub-modules of the customized device identification methods of 6A and 6B.

FIG. 8 is a table showing exemplary information to collect from various user devices in accordance with certain embodiments.

FIG. 9 is a block diagram of an exemplary computer system, which may implement the various components of FIGS. 1, 2A, 2B, and 3.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “computer system configured to authenticate a remote computer system” is intended to cover, for example, a computer system has circuitry that performs this function during operation, even if the computer system in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, references to “first” and “second” computer system would not imply a temporal ordering between the routines unless otherwise stated.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

As used herein, the word “module” refers to structure that stores or executes a set of operations. A module refers to hardware that implements the set of functions, or a memory storing the set of instructions such that, when executed by one or more processors of a computer system, cause the computer system to perform the set of operations. A module may thus include an application-specific integrated circuit implementing the instructions, a memory storing the instructions and one or more processors executing said instructions, or a combination of both.

### DETAILED DESCRIPTION

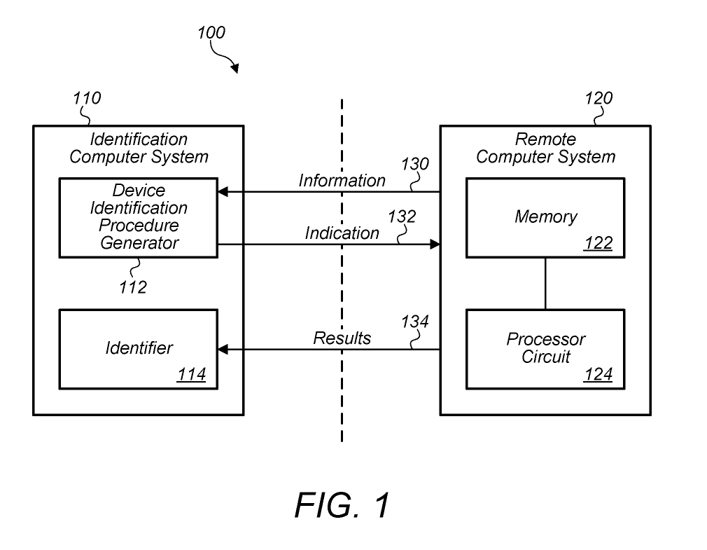

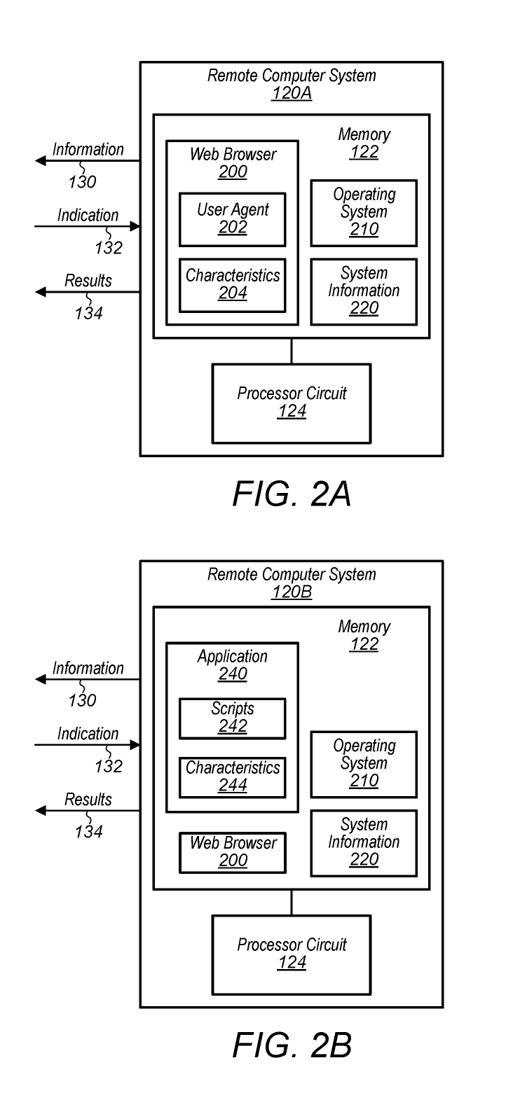

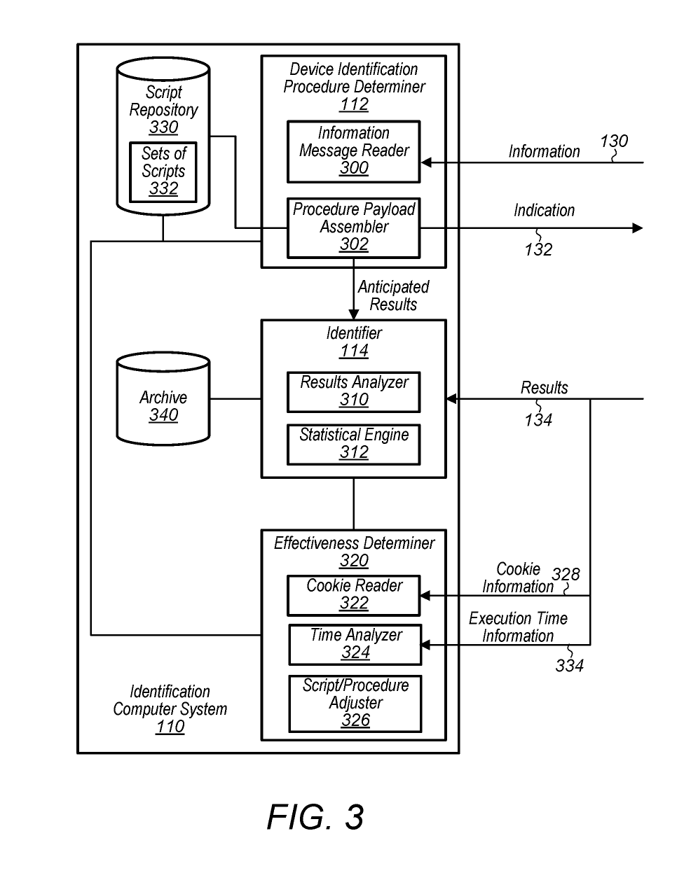

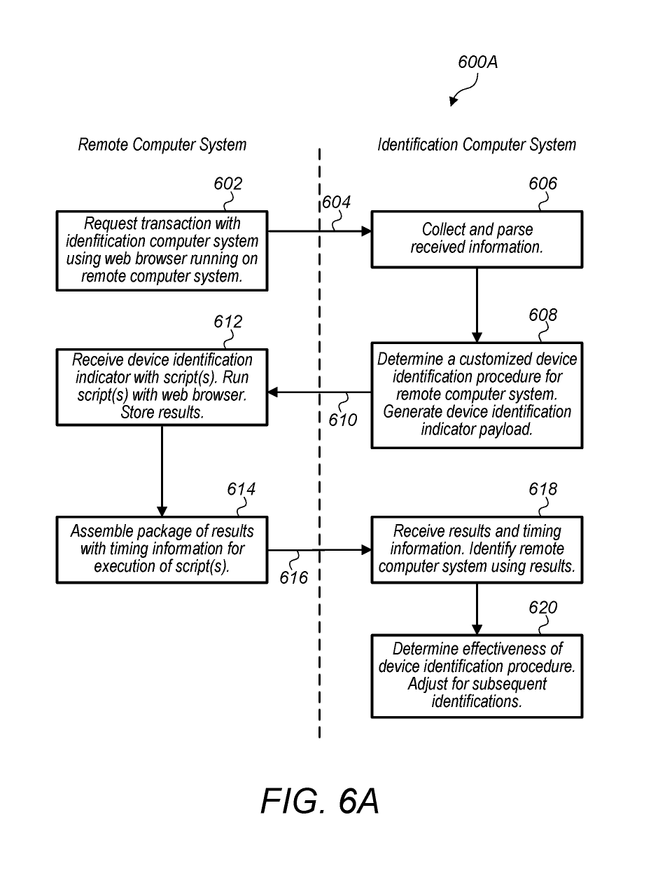

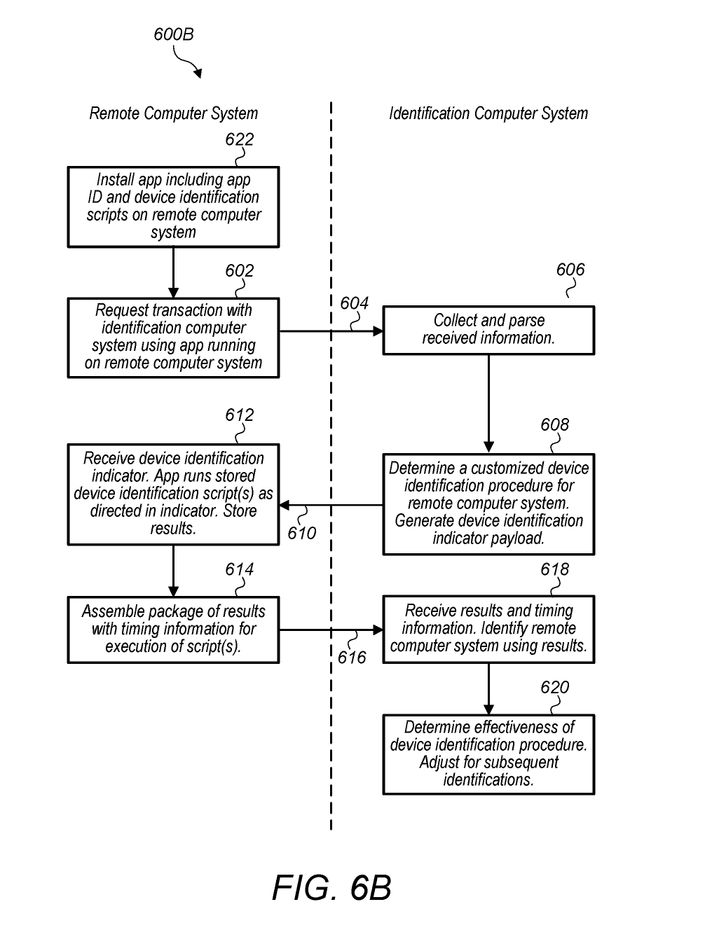

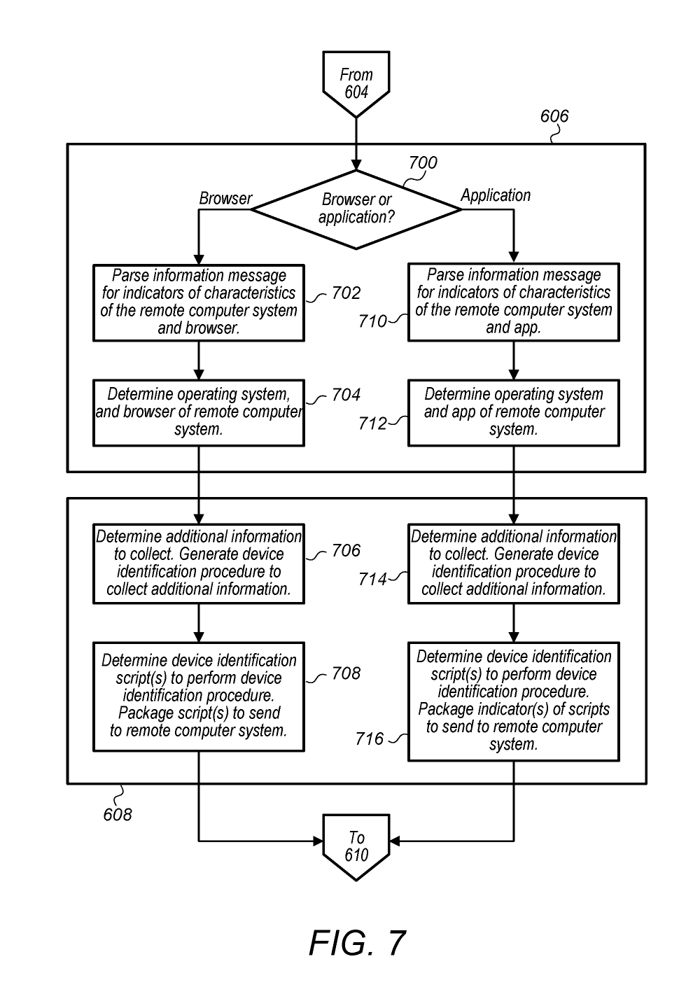

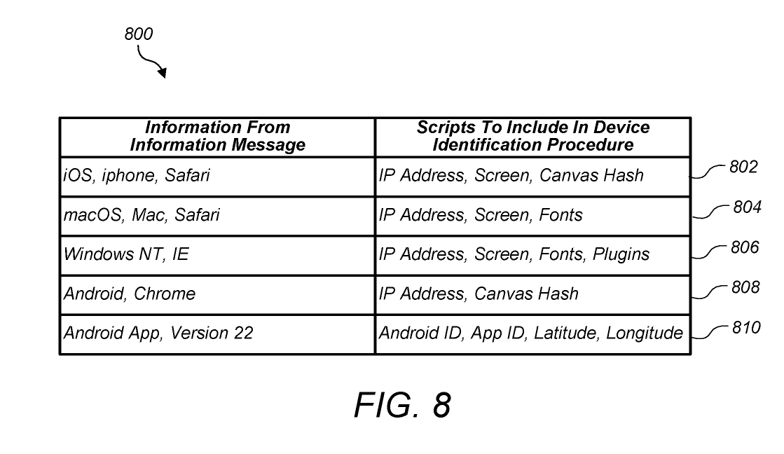

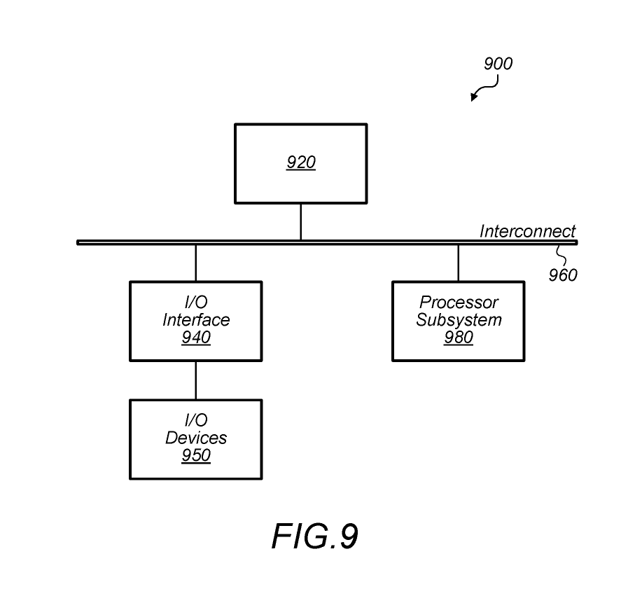

This disclosure describes techniques for script-based identification of a remote computer system by an identification computer system. Broad embodiments of the identification computer system and remote computer system (and the respective tasks performed by each during the identification process) are described in reference to FIGS. 1, 4, and 5. Further details relating to the remote computer systems are discussed with references to FIGS. 2A and 2B. An exemplary identification computer system is discussed with reference to FIG. 3. Further details relating to the identification process are described in reference to FIGS. 6A, 6B, and 7. An exemplary table showing exemplary information to collect from various remote computer system with various hardware and software configurations is shown in FIG. 8. Finally, an exemplary computer system, which may implement the various components of FIGS. 1, 2A, 2B, and 3, is discussed with reference to FIG. 9.

Referring now to FIG. 1, a block diagram of an exemplary network environment 100 is depicted. In the illustrated embodiment, network environment 100 includes an identification computer system 110 and a remote computer system 120 (also referred to herein as a “user device”). Identification computers system 110 and remote computer system 120 may be coupled to and exchange messages by any number of wired or wireless networks (e.g., the Internet). In the illustrated embodiment, identification computer system 110 includes a device identification procedure generator module 112 and an identifier module 114. Remote computer system 120 includes a memory 122 and a processor circuit 124. During operation, remote computer system 120 sends an information message 130 to device identification procedure generator module 112 of identification computer system 110. Device identification procedure generator module 112 of identification computer system 110 sends an indication message 132 to remote computer system 120. Remote computer system 120 sends a results message to identifier modules 114 of identification computer system 110.

Identification computer system 110 may be one or more computer systems communicating with one or more remote computer systems 120. Identification computer system 110 may be implemented on dedicated hardware (e.g., a dedicated server) or implemented as a process running on a cloud computing platform. Identification computer system 110 may be coupled to or integrated with a transaction computer system (not shown). Herein, the transaction computer system is discussed as being separate from identification computer system 110, but it will be understood that the transaction computer system and identification computer system 110 may comprise the same computer hardware (e.g., a computer server) executing the tasks associated with identification computer system 110 and a transaction computer system. In some instances, remote computer system 120 may communicate, directly or through identification computer system 110, with a transaction computer system (not shown) to request to execute a transaction. Before the transaction computer system (not shown) accepts or rejects the request to execute the transaction, identification computer system 110 may identify remote computer system 120 as discussed herein. Transactions may include, for example, purchases of goods or services, technical support, registration for a service, a log on request for a website, or any other instance when determining that a remote computer system is a particular remote computer system is useful. Device identifier procedure module 112 and identifier modules are discussed in further detail herein in reference to FIG. 3.

Remote computer system 120 may be any of a number of computing devices used to access a transaction computer system (not shown) and/or an identification computer system 110. For example, remote computer system 120 may be a desktop computer, laptop computer, computer server, tablet computer, smart phone, wearable computer (e.g., a smart watch), etc. Memory 122 and processor circuit 124 of remote computer system 120 are discussed in further detail herein in reference to FIG. 2A and FIG. 2B.

Messages 130, 132, and 134 (an information message 130, an indication message 132, and a results message 134, respectively) include information that may be used in connection with the methods discussed herein to facilitate the identification of remote computer system 120 by identification computer system 110. In some embodiments, information message 130 is an HTTP user agent string and includes user agent information. Information message 130 includes information about the software running on remote computer system 120. In some embodiments, information message 130 includes information that specifies at least one characteristic of remote computer system 120 and at least one characteristic a program running on remote computer system 120 (e.g., a web browser or application as discussed herein). For example, information message 130 may include information indicating the operating system (e.g., a Windows®-based operation system, an iOS®-based operation system, an Android®-based operation system, etc.) running on remote computer system 120. As discussed herein with connection to FIGS. 2A and 2B, information message 130 may include information about other software running on remote computer system 120 such as a web browser (e.g., Google's Chrome®, Apple's Safari®, Microsoft's Internet Explorer® or Edge®, Mozilla's Firefox®, etc.) or a program that is not a dedicated web browser.

In some embodiments, information message 130 specifies a particular operating system running on remote computer system 120 and a particular web browser running on remote computer system 120. These embodiments are discussed further in connection to FIG. 2A. In some embodiments where remote computer system 120 is a mobile device running a mobile application, information message 130 specifies the operating system of the mobile device and the mobile application. These embodiments are discussed further in connection to FIG. 2B. Information message 130 may also include information about the hardware of remote computer system 120. For example, information message 130 may indicate whether remote computer system 120 is a personal computer (e.g., desktop computer, laptop computer) or a mobile device (e.g., tablet computer, smart phone, wearable computer, etc.). Information message 130 may also indicate other information about remote computer system 120 such as information about processor circuit 124.

Indication message 132 includes an indication of the device identification procedure (e.g., a script-based device identification procedure) generated by device identification procedure generator module 112. As discussed herein, the device identification procedure specifies one or more scripts executable by remote computer system 120 and is customized for remote computer system 120 based on received information message 130. As used herein, a device identification procedure is said to be “customized” for remote computer system 120 if the one or more scripts are selected based on information received from remote computer system 120. For example, selection of one or more scripts based on received information about an operating system running on remote computer system 120 constitutes a “customized” device identification procedure as used herein, and stands in contrast, for example, to a “generic” device identification procedure in which the same one or more scripts are selected regardless of the properties of a particular remote computer system 120.

Examples of various scripts comprising a customized device identification procedure are discussed herein in connection to FIG. 8. In some embodiments, indication message 132 includes the one or more scripts of the customized device identification procedure and sending indication message 132 includes sending the one or more scripts to remote computer system 120. Such embodiments are discussed here in in further detail in connection to FIGS. 2A, 6A, and 7. In other embodiments, indication message 132 includes script information specifying the one or more scripts of the customized device identification procedure and sending indication message 132 includes sending the script information but not the one or more scripts to remote computer system 120. Such embodiments are discussed herein in further detail in connection to FIGS. 2B, 6B, and 7. Thus, indication messages 132 may variously include scripts to be executed by remote computer system 120 or merely specify such scripts.

In a script-based device identification process, the various scripts indicated by the device identification procedure are executed by remote computer system 120 to produce a set of results (e.g., the results included in results message 134). For a given script, the results from a particular remote computer system 120 from executing the script will likely differ from the results of other remote computer system 120 because of differences in software and hardware in each individual remote computer system 120. For example, some scripts involve remote computer system 120 making a number of calculations, and these calculations will likely differ from the calculations made by other remote computer systems 120 because of, for example, different configurations of operating system among remote computer systems 120, slight manufacturing variations in the hardware of a particular model of microprocessor used in a particular model of remote computer system 120. Other scripts, for example scripts to determine the IP address of remote computer system 120, may produce different results based on the geographic locations of various remote computer systems 120. Accordingly, even remote computer systems 120 of the same make and model and made in the same factory run will likely have some variations between them, and these differences may be detected with the appropriate set of scripts.

Use of a customized device identification procedure for a particular remote computer system 120 may advantageously streamline the identification process, thereby making the identification process faster and/or more efficient. Use of a customized device identification procedure may reduce or eliminate non-relevant scripts for a particular remote computer system 120, as compared to use of a generic device identification procedure. It may commonly be the case that use of a generic device identification procedure will cause a script to be run on a remote computer system 120 even though it is not relevant or applicable to that computer system. For example, various web browsers and/or operating systems running on various embodiments of remote computer systems 120 may block requests for the geographic location of the remote computer systems 120, so a script to determine geographic location would not be relevant. As a second example, certain remote computer systems 120 (e.g., mobile devices such as mobile phones or tablet computers) may not be configured such that additional fonts may be installed beyond the fonts available by default, so determining the fonts that are installed on such remote computer systems 120 would not be helpful to identify a particular remote computer system 120 because all remote computer systems 120 of that make and model would have the same fonts installed. Use of customized device identification procedures thus may prevent expending unnecessary computing resources of remote computer system 120, particularly since non-relevant scripts will not ultimately be useful in identifying remote computer system 120.

Further, in some embodiments, because a particular remote computer system 120 may be identified using the results of a subset of the available device identification scripts (e.g., the results of three out of twenty available scripts), the use of a customized device identification procedure may advantageously streamline the identification process by reducing the number of scripts executed by the remote computer system 120. In such cases, requesting that a remote computer system 120 execute more identification scripts than necessary to identify remote computer system 120 can degrade performance and/or the user experience by slowing down communication with identification computer system 110. For example, if a particular remote computer system 120 is being used to make a purchase on a website and script-based identification is used to identify the particular remote computer system 120, too long of a period of time between the request to make the purchase and approving the purchase may be unacceptable or confusing to the user. If, for example, a minute elapsed between the request and approval, a user might be frustrated or think there was a technical problem. Accordingly, it may be useful to only have remote computer system 120 execute just enough scripts to make an identification but without unduly slowing down the process. Additionally, because different models of remote computer systems 120 may have different hardware (e.g., processor circuits, displays) and different software (e.g., operating system, web browser), a generic device identification script may be customized for a particular remote computer system 120 by omitting scripts that are not relevant to the particular hardware and software of the particular remote computer system 120. For example, a remote computer system 120 running Windows 10® and the Google Chrome® web browser may be sent a customized script that just applies to systems running Windows 10® and Google Chrome®, and omitting scripts that are only relevant to remote computer systems 120 running iOS® or Android® operating systems.

Results message 134 includes a set of results produced by execution of the one or more scripts specified by indication message 132 by remote computer system 120. Such results may be based on the various scripts in the device identification procedure and the type of information that device identification procedure generator module 112 determines to collect. As discussed herein, such results are indicative of additional characteristics of remote computer system 120 and are determined as a result of executing the various scripts in the device identification procedure. The generation of the device identification procedure is discussed in further detail herein in connection to FIGS. 7 and 8. For example the set of results may include an IP address of remote computer system 120, information about a display screen (e.g., dimensions, resolution, etc.) coupled to remote computer system 120, a result of a canvas fingerprinting script in raw form or in hashed form, a list of the fonts stored on remote computer system 120, a list of the web browser plugins stored on remote computer system 120, an operating system identification code, a user-agent program identification code, a location of remote computer system 120 (e.g., latitude, longitude, city, region, country, or a combination). In some embodiments, the set of results may also include information about the execution time of the one or more scripts. The information about the execution time may include the amount of time the remote computer system 120 took to execute the individual scripts of the customized device identification procedure, the time that remote computer system 120 took to execute the entire customized device identification procedure, and/or information about a communication latency between identification computer system 110 and remote computer system 120.

In various embodiments, the components of network environment 100 work together to identify remote computer system 120 in order to determine whether remote computer system 120 is known to be trustworthy, suspected or known to be associated with fraudulent or malicious activity, heretofore unknown to identification computer system 110, or cannot be identified without additional information. If remote computer system 120 is known to be trustworthy, identification computer system 110 (and, in embodiments, a transaction computer system (not shown)) may determine to execute one or more transactions with remote computer system 120. If remote computer system 120 is suspected or known to be associated with fraudulent or malicious activity, identification computer system 110 (and, in embodiments, a transaction computer system (not shown)) may determine to block communications from remote computer system 120, decline to execute one or more transactions with remote computer system 120, or seek further information from remote computer system 120 before executing any transactions with remote computer system 120. If remote computer system 120 was heretofore unknown or cannot be authenticated without additional information, identification computer system 110 (and, in embodiments, a transaction computer system (not shown)) may seek further information (e.g., request remote computer system 120 to execute additional scripts, request information from the user like additional passwords or login credentials, etc.) before executing any transactions with remote computer system 120.

Previously, identifying a remote computer system 120 may have been done through the use of tagged identification procedures (e.g., with a cookie or the like stored on remote computer system 120). However, in various circumstances, the use of tagged identification may not be permitted or practicable. For example, some web browsers block the use of third-party cookies (e.g., a cookie from an identification computer system 110) when remote computer system 120 running the web browser is accessing a webpage associated with a transaction computer system. Some remote computer systems 120 may not accept cookies or ban their use. Accordingly, a script-based identification procedure may be a better way to identify remote computer system 120. In various embodiments, such script-based identification procedures may be performed without the use of a cookie or other tag and may be referred to as a “tagless identification procedure.” Alternatively, in some embodiments, script-based identification may be supplemented with a tagged identification procedure to, for example, check the accuracy of a script-based device identification procedure as discussed herein.

It may be important to identify, with an identification computer system 110, a remote computer system 120 accessing a transaction computer system (not shown) for any number of reasons. If identification computer system 110 is able to identify a particular remote computer system 120 from among other remote computer systems 120, the functionality of the network environment 100 may be improved in a number of ways. If the particular remote computer system's 120 capabilities are known, the communication and content between the transaction computer system and the particular remote computer system 120 may be tailored to be more optimized for the particular remote computer system 120. Further, if the transaction computer system is engaging in a technical support or troubleshooting procedure with the particular remote computer system 120 and its user, determining the identity of the particular remote computer system 120 may aid in the procedure by associating previous technical support actions with the particular remote computer system 120 and tailoring the technical support procedures to the configuration of the particular remote computer system 120. Further still, by determining that a particular remote computer system 120 is associated with previous acts of fraud or malicious activity, the transaction computer system and/or identification computer system 110 may block further fraudulent or malicious activity that the particular remote computer system 120 (and its user) may be trying to perpetrate. Additionally, a particular remote computer system 120 may be associated with a profile and served advertisements or content relevant to that profile.

Referring now to FIG. 2A, a block diagram of an exemplary remote computer system 120A is depicted. As discussed in relation to FIG. 1, remote computer system 120A includes a memory 122 and a processor circuit 124. In the depicted embodiment, memory 122 includes a web browser 200, an operating system 210, and system information 220. Web browser 200 includes a user agent 202 and one or more characteristics 204. Remote computer system 120A may be any of a number of computer systems running a web browser 200 and an operating system 210 including but not limited to a desktop computer, laptop computer, computer server, tablet computer, smart phone, wearable computer (e.g., a smart watch), etc.

Memory 122 is usable to store program instructions executable by processor circuit 124 to cause remote computer system 120A perform various operations described herein. Memory 122 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in remote computer system 120A is not limited to primary storage such as memory 122. Rather, remote computer system 120A may also include other forms of storage such as cache memory in processor circuit 124 and secondary storage on I/O Devices (e.g., a hard drive, storage array, etc.) (not shown). In some embodiments, these other forms of storage may also store program instructions executable by processor circuit 124. Processor circuit 124 may include one or more processors or processing units. In various embodiments, processor circuit 124 (or each processor unit within 124) may contain a cache or other form of on-board memory.

Web browser 200 is a program running on remote computer system 120A. Web browser 200 is configured to receive facilitate communication between remote computer system 120A and identification computer system 110 and/or a transaction computer system (not shown), for example, by receiving and sending information (e.g., messages 130, 132, and 134). Web browser 200 may be any of a number of available web browsers including but not limited to Google's Chrome®, Apple's Safari®, Microsoft's Internet Explorer® or Edge®, or Mozilla's Firefox® web browsers. Web browser 200 receives information and may render it in a manner that a user may understand (e.g., by rendering a webpage, by playing a video, etc.) and interact with. Web browser 200 is configured to execute scripts received from identification computer system 110 and output results of executing the scripts in furtherance of performing the customized device identification procedure discussed herein.

User agent 202 is an aspect of web browser 200 that acts on behalf of a user of remote computer system 120A when he or she accesses a webpage with remote computer system 120A. As part of the functionality of user agent 202, user agent 202 provides information about remote computer system 120A to other computer systems with which web browser 200 is communicating. In such embodiments, the information provided includes information about web browser 200 and about operating system 210. The information provided by user agent 202 is included in information message 130. In some embodiments, information message 130 includes a user agent string. Table 1 includes three exemplary user agent strings generated by a web browser 200:

TABLE 1

| | |
|---|---|
| User Agent | Mozilla/5.0 (iPad; U; CPU OS 3_2_1 like Mac OS X; |
| String 1 | en-us) AppleWebKit/531.21.10 (KHTML, like Gecko) |
| | Mobile/7B405 |
| User Agent | Mozilla/5.0 (Windows NT 10.0; Win64; x64) |
| String 2 | AppleWebKit/537.36 (KHTML, like Gecko) Chrome/ |
| | 58.0.3029.110 Safari/537.36 |
| User Agent | Mozilla/5.0 (Windows NT 10.0; Win64; x64) |
| String 3 | AppleWebKit/537.36 (KHTML, like Gecko) Chrome/ |
| | 51.0.2704.79 Safari/537.36 Edge/14.14393 |

User Agent String 1 in Table 1 corresponds to a remote computer system 120A that is an iPad running the Safari® web browser 200. User Agent String 2 in Table 1 corresponds to a remote computer system 120A that is a desktop computer running the Windows® 10 operating system 210 and the Chrome® web browser 200. User Agent String 3 in Table 1 corresponds to a remote computer system 120A that is a desktop computer running the Windows® 10 operating system 210 and the Edge® web browser 200. Each of the user agents in Table 1 include five components. “Mozilla/5.0” in each user agent string in Table 1 indicates that each web browser 200 is compatible with the Mozilla rendering engine. The “(iPad; U; CPU OS 3_2_1 like Mac OS X; en-us)” in User Agent String 1 and “(Windows NT 10.0; Win64; x64)” in User Agent Strings 2 and 3 indicate details of remote computer system 120A in which the respective web browsers 200 are running. The “AppleWebKit/531.21.10” in User Agent String 1 and “AppleWebKit/537.36” in User Agent Strong 2 and 3 indicate the platform used by the respective web browsers 200. “(KHTML, like Gecko)” in each user agent string indicates details about the browser platform of the respective web browsers 200. The “Mobile/7B405,” “Chrome/58.0.3029.110 Safari/537.36”, and “Chrome/51.0.2704.79 Safari/537.36 Edge/14.14393” of the user agent strings indicate specific enhancements that are available directly in web browser 200 or through third parties (e.g., plug-ins for web browser 200) and may indicate the software version of web browser 200. For example, User Agent String 2 corresponds to a remote computer system 120A running Chrome® version 58.0.3029.110.

Characteristics 204 includes various aspects of web browser 200 running on a particular remote computer system 120A that may be usable to differentiate the particular remote computer system 120A from other remote computer systems 120A. For example, such characteristics may include the version of web browser 200, plugins to web browser 200, fonts installed on web browser 200, etc.

Operating system 210 may be any of a number of types of system software that manages the computer hardware and software resources of remote computer system 120A and provides common services for computer programs running on remote computer system 120A. In various embodiments, operating system 210 may be the Microsoft Windows® operating system, Apple iOS® operating system, Apple macOS® operating system, Google Android® operating system, Linux® operating system, Unix® operating system, or other operating systems 210.

System information 220 may be any of a number of characteristics describing various aspects of the hardware of remote computer system 120A (e.g., make and/or model of remote computer system 120A, information about processor circuit 124, information about the hardware comprising memory 122). In various embodiments, system information 220 includes information about devices coupled to remote computer system 120A (e.g., displays, storage devices, input devices, cameras, etc.). In various embodiments, system information 220 includes information about the function of remote computer system 120A including but not limited to the IP address of remote computer system 120A, a geographic location (e.g., latitude, longitude, etc.) of remote computer system 120A, an operating temperature of memory 122 or processor circuit 124, a voltage measurement of memory 122 or processor circuit 124, a current measurement of memory 122 or processor circuit 124, a power measurement of memory 122 or processor circuit 124, etc. System information 220 may be accessed as part of executing a customized device identification procedure as discussed herein in an attempt to differentiate a particular remote computer system 120A from other remote computer systems 120A.

In operation, remote computer system 120A includes a user agent string in information message 130 and sends information message 130 to identification computer system 110. Remote computer system 120A receives indication message 132 including the customized device identification procedure and the scripts that remote computer system 120A is to perform as part of the customized device identification procedure. Remote computer system 120A performs the various scripts and sends the results to identification computer system 110 in results message 134.

Referring now to FIG. 2B, a block diagram of another exemplary remote computer system 120B is depicted. As discussed in relation to FIG. 1, remote computer system 120B includes a memory 122 and a processor circuit 124. In the depicted embodiment, memory 122 includes an application 240, an operating system 210, and system information 220. Application 240 includes a plurality of scripts 242, and characteristics 244. Remote computer system 120B may be any of any number of computer systems running an application 240 and an operating system 210 including but not limited to a desktop computer, laptop computer, computer server, tablet computer, smart phone, wearable computer (e.g., a smart watch), etc.

Memory 122 is usable to store program instructions executable by processor circuit 124 to cause remote computer system 120B perform various operations described herein. Memory 122 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in remote computer system 120B is not limited to primary storage such as memory 122. Rather, remote computer system 120B may also include other forms of storage such as cache memory in processor circuit 124 and secondary storage on I/O Devices (e.g., a hard drive, storage array, etc.) (not shown). In some embodiments, these other forms of storage may also store program instructions executable by processor circuit 124. Processor circuit 124 may include one or more processors or processing units. In various embodiments, processor circuit 124 (or each processor unit within 124) may contain a cache or other form of on-board memory.

Application 240 is any of a number of programs that may be installed on remote computer system 120B that are distinct from a web browser (not shown) that may be installed on remote computer system 120B. In various embodiments, remote computer system 120B is a mobile device (e.g., a mobile phone, tablet computer) and application 240 is a mobile application or app installed on the mobile device that is distinct from mobile browser programs (e.g., one or more web browsers) installed on the mobile device. For example, the mobile application may be a game application with functionality permitting a user to make in-game purchases, or a shopping application with functionality permitting a user to purchase goods or services directly in the application 240 without launching a separate web browser.

Scripts 242 are a plurality of device identification scripts that may be performed as part of a customized device identification procedure as discussed herein. In various embodiments, each individual script 242 is associated with a unique identifier. As discussed herein, the indication message 132 may include the identifiers associated with the various scripts to be performed by the remote computer system 120B as part of the customized device identification procedure. Scripts 242 may also include parameters that may be modified by information included in indication message 132 such as, for example, a seed random number, that may modify the execution of scripts 242 that are executed. Scripts 242 performed as part of the customized device identification procedure may be a subset of scripts 242 stored on remote computer system 120B. For example, a customized device identification procedure may call for the execution of four scripts 242 out of a total of twenty available scripts 242.

Characteristics 244 includes various aspects of application 240 running on a particular remote computer system 120B that may be usable to differentiate the particular remote computer system 120B from other remote computer systems 120B. For example, such characteristics may include an app ID code associated with a particular application 240 (e.g., the game application and shopping application discussed above may each have unique app ID codes), the version of application 240, user configurable settings applied to application 240, etc.

As part of the functionality of application 240, application 240 provides information about remote computer system 120B to other computer systems with which application 240 is communicating. In such embodiments, the information provided includes information about application 240 and about operating system 210. In various embodiments, additional information such as locale and time zone of the remote computer system 120B is provided. Table 2 includes two exemplary sets of information provided by a remote computer system 120B.

TABLE 2

| | |
|---|---|
| Remote | Device Model: iphone5s |
| Computer | Operating System: iOS |
| System | Operating System Version: 10.3.1 |
| Alpha | Locale: United States |
| | Time Zone: −5.00 |
| | Application ID: 0123456 |
| Remote | Device model: Nexus 7 |
| Computer | Operating System: Android |
| System | Operating System Version: 22 |
| Beta | Locale: United States |
| | Time Zone: −7.00 |
| | Application ID: 6543210 |

In the example shown in Table 2, Remote Computer System Alpha is an Apple iPhone 5S® and Remote Computer System Beta is a Google Nexus 7®. In these examples, the remote computer system 120B provides information about itself including the device model, operating system, operating system version, locale, and time zone of the respective device as well as the application ID of application 240. In the case of System Alpha, for example, application 240 provide information indicating that System Alpha is an Apple iPhone 5S® running iOS version 10.3.1 and application 0123456, and System Alpha is located in the United States in the Central Time Zone. Similarly, the application 240 of System Beta provides information indicating that System Beta is a Google Nexus 7® running Android version 22 and application 6543210, and System Beta is located in the United States in the Pacific Time Zone.

The information provided by application 240 is included in information message 130. An information message 130 sent by application 240 running on remote computer system 120B will differ from an information message 130 sent by a web browser 200 running on a remote computer system 120A such that identification computer system 110 is able to determine that the former information message 130 was provided by an application 240 and the latter information message was provided by a web browser 200.

Operating system 210 may be any of a number of types of system software that manages the computer hardware and software resources of remote computer system 120B and provides common services for computer programs running on remote computer system 120B. In various embodiments, operating system 210 may be the Microsoft Windows® operating system, Apple iOS® operating system, Apple macOS® operating system, Google Android® operating system, Linux® operating system, Unix® operating system, or other operating systems 210.

System information 220 may be any of a number of characteristics describing various aspects of the hardware of remote computer system 120B (e.g., make and/or model of remote computer system 120B, information about processor circuit 124, information about hardware comprising memory 122). In various embodiments, system information 220 includes information about devices coupled to remote computer system 120B (e.g., displays, storage devices, input devices, cameras, etc.). In various embodiments, system information 220 includes information about the function of remote computer system 120B including but not limited to the IP address of remote computer system 120B, a geographic location (e.g., latitude, longitude, etc.) of remote computer system 120B, an operating temperature of memory 122 or processor circuit 124, a voltage measurement of memory 122 or processor circuit 124, a current measurement of memory 122 or processor circuit 124, a power measurement of memory 122 or processor circuit 124, etc. System information 220 may be accessed as part of executing a customized device identification procedure as discussed herein in an attempt to differentiate a particular remote computer system 120B from other remote computer systems 120B.

In operation, remote computer system 120B includes information about the operating system 210, system information 220, and application 240 in information message 130 and sends information message 130 to identification computer system 110. Remote computer system 120B receives indication message 132 including the customized device identification procedure and indicators of which of scripts 242 the remote computer system 120B (but not the one or more device identification scripts themselves) is to perform as part of the customized device identification procedure. Remote computer system 120B performs the indicated scripts 242 and sends the results to identification computer system 110 in results message 134.

Referring now to FIG. 3, a block diagram of an exemplary identification computer system 110 is depicted. As discussed in connection to FIG. 1, identification computer system 110 includes a device identification procedure generator module 112 and identifier module 114. In the illustrated embodiment, device identification procedure generator module 112 includes an information message reader module 300 and a procedure payload assembler module 302. In the illustrated embodiment, identifier module 114 includes results analyzer module 310 and statistical engine module 312. As shown in FIG. 3, identification computer system 110 further includes an effectiveness determining module 320, a script repository 330, and an archive 340. In various embodiments, effectiveness determining module 320 includes a cookie reader module 322, time analyzer module 324, and script/procedure adjuster module 326. Script repository 330 includes a set of device identification scripts 332.

Device identification procedure generator module 112 receives information message 130 from a remote computer system 120, determines a customized device identification procedure for remote computer system 120 based on received information message 130, and sends an indication of the customized device identification procedure to remote computer system 120 in indicator message 132. Information message reader module 300 receives an information message 130 that includes information about the remote computer system 120 indicating at least one characteristic of remote computer system 120 and at least one characteristic of a program (e.g., web browser 200, application 240) running on remote computer system 120. In various embodiments where information message 130 includes a user agent string, information message reader module 300 parses the user agent string and determines information about remote computer system 120 that may be used to customized the device identification procedure. As discussed herein, information message 130 may indicate whether the program running on remote computer system 120 is a web browser 200 or an application 240 as well as information about the specific program and operating system 210 running on remote computer system 120. In various embodiments, information message reader module 300 determines the type of program being run by remote computer system 120 (e.g., web browser 200 or application 240), the particular program being run by remote computer system 120 (e.g., Google Chrome®, Microsoft Edge®, a particular game application, etc.), and operating system 210 running on remote computer system 120.

Based on the information gathered by information message reader module 300, procedure payload assembler module 302 determines a customized device identification procedure for the particular remote computer system 120 from which information message 130 was received. The customized device identification procedure specifies one or more scripts executable by a remote computer system 120, either be including the scripts themselves or indicators of the scripts (but not the scripts themselves) as discussed herein.

In various embodiments, the procedure payload assembler module 302 accesses script repository 330 and selects one of a plurality of predetermined set of device identification scripts 332 to be used to collect additional information about the particular remote computer system 120. Procedure payload assembler module 302 may base this selection in part on the type of program being run by remote computer system 120, the particular program being run by remote computer system 120, and/or the operating system running on remote computer system 120. In such embodiments, each set of device identification scripts 332, when executed by a remote computer system 120 having a particular characteristic (e.g., running a particular operating system) and running a particular program (e.g., Google Chrome®) will produce a set of anticipated results. Such anticipated results are predicted to be sufficient to differentiate a particular remote computer system 120 having the particular characteristic and running the particular program from another remote computer system 120 also having the particular characteristic and running the particular program. For example, a first set of scripts is associated with a first particular operating system (e.g., Microsoft Windows®) and a first particular web browser (e.g., Google Chrome®) and a second set of scripts is associated with a second particular operating system (e.g., Apple iOS®) and a second particular web browser (e.g., Mozilla Firefox®). In such embodiments, the customized device identification procedure includes the set of scripts 332 associated with the particular characteristic and running the particular program of the particular remote computer system 120.

In other embodiments, procedure payload assembler module 302 accesses script repository 330 and assembles various individual scripts on the fly to be used to collect additional information about the particular remote computer system 120. Procedure payload assembler module 302 may base this selection on the type of program being run by remote computer system 120, the particular program being run by remote computer system 120, and/or the operating system running on remote computer system 120. In embodiments where remote computer system 120 is running a web browser 200, procedure payload assembler module 302 generates an indication message 132 including the selected scripts. In embodiments where remote computer system 120 is running an application 240, procedure payload assembler module 302 generates an indication message 132 including indicators of the selected scripts (but not the scripts themselves). After generation, procedure payload assembler module 302 sends indication message 132 to remote computer system 120. In various embodiments, procedure payload assembler module 302 sends a set of anticipated results for the scripts included in the customized device identification procedure that identifier module 114 may compare to the results of results message 134.

In various embodiments, identifier module 114 includes results analyzer module 310 which receives results message 134 from remote computer system 120, and attempts to identify the particular remote computer system. In such embodiments, results analyzer module 310 may be coupled to archive 340. Archive 340 stores data indicative of previously identified remote computer systems 120. For example, a first previously identified remote computer system 120 is associated with a first set of results from executing various device identification scripts and a second previously identified remote computer system 120 is associated with a second set of results from executing various device identification scripts, etc. Results analyzer module 310 may identify the particular remote computer system 120 from which results message 134 was received by comparing the set of results contained in results message 134 to the set of results to data indicative of previously identified remote computer systems. Results analyzer module 310 may determine that the particular remote computer system 120 corresponds to a previously identified remote computer system 120 by comparing a first portion of the set of results from result message 134 (e.g., a canvas hash generated by remote computer system 120 and the time taken by remote computer system 120 to generate the canvas hash) to a corresponding portion of previously received sets of results, comparing a second portion of the set of results from result message 134 (e.g., an IP address of remote computer system 120) to a corresponding portion of previously received sets of results, and so on. In this way, results analyzer module 310 may compare all of the received results in results message 134 to previously received sets of results.

Depending on the script, this comparison may include checking whether the results in result message 134 exactly correspond to a previous received set of results exactly, within an amount of uncertainty, or both. In operation if the set of results included in the results message 134, received from a particular remote computer system 120, exactly or substantially (e.g., within a threshold amount of uncertainty) match a previously received set of results corresponding to a remote computer system 120, results analyzer module 310 may determine that the particular remote computer system 120 and the previously identified remote computer system 120 are one in the same. In some instances, however, results analyzer module 310 may determine that the set of results included in results message 134 matches more than one previous received sets of results, in which case identifier module 114 may determine that additional information (e.g., the results of executing additional scripts) is needed to identify the particular remote computer system. Further, the results analyzer module 310 may determine that the set of results included in results message 134 does not correspond to any of the previously received sets of results and that the particular remote computer system 120 cannot be identified without additional information from the particular remote computer system 120 (e.g., the results of executing additional scripts) or from the user of remote computer system 120 (e.g., additional login information such as passwords, answers to security questions, two-factor identification, etc.).

In various embodiments, some of the various previously known remote computer systems 120 may be associated with a blacklist. In such embodiments, the blacklist includes previously known remote computer systems 120 that have been determined to be untrustworthy and/or suspected of being associated with fraud, abuse, etc. If the results analyzer module 310 determines that the particular remote computer system from which results message 134 was received is on the blacklist, based on this determination, identification computer system 110 and/or transaction computer system may reject a transaction request from remote computer system 120 or request additional information or assurances from the user of remote computer system 120. In various embodiments, some of the various previously known remote computer systems 120 may be associated with a whitelist of approved remote computer systems 120 that have been previously determined to be trustworthy. If results analyzer module 310 determines that the particular remote computer system from which results message 134 was received is on the whitelist, based on this determination, identification computer system 110 and/or transaction computer system may accept a transaction request from remote computer system 120. In various embodiments, if the particular remote computer system 120 is neither on a blacklist nor a whitelist, identification computer system 110 may request additional information from the particular remote computer system 120 (e.g., the results of executing additional scripts) or from the user of remote computer system 120 (e.g., additional login information such as passwords, answers to security questions, two-factor identification, etc.).

In various embodiments, statistical engine module 312 is used to determine a certainty of how closely the received set of results included in results message 134 corresponds to one or more previously received sets of results using statistical analysis techniques. For example, statistical engine module 312 may assign a confidence score to the determination that the set of results included in results message 134 matches one or more previously received sets of results. In various embodiments, statistical engine module 312 may apply different weights to the various sets of results (e.g., weighting a canvas hash result more than an IP address result). The certainty determined by statistical engine module 312 may be used to aid results analyzer module 310 in its determination that a set of results included in results message 134 correspond (or do not correspond) to a particular previously received set of results (e.g., by informing that a particular match has a low confidence score and may not be accurate). Additionally, the certainty determined by statistical engine module 312 may be used to aid effectiveness determiner module 320 to improve or adjust the device identification procedure as discussed herein.

In various embodiments, effectiveness determining module 320 is configured to generate a revised device identification procedure that is available for subsequent identifications. In such embodiments, the generation of the revised device identification procedure is based on the set of results included in results message 134 and the comparing performed by identifier module 114 (e.g., whether identifier module 114 was able to successfully match the set or results with a previously received set of results, whether such a match had a high confidence score). In such embodiments, the revised device identification procedure is not identical to the previously used customized device identification procedure. The revised device identification procedure may be stored in script repository 330. The revision of the device identification procedure may be based on the output of a cookie reader module 322 and/or time analyzer module 324. In various embodiments, a script/procedure adjuster module 326 is used by effectiveness determiner module 320 to revise a device identification procedure and/or adjust the scripts used in the device identification procedure.

In various embodiments, cookie reader module 322 receives (e.g., included in result message 134) cookie information 328 related to a cookie storied on remote computer system 120. As discussed herein, the script-based identification procedure disclosed herein may be used to identify a particular remote computer system 120 without the use of a cookie. The use of a cookie, however, may allow identification computer system 110 to check the accuracy of such identifications. For example, if in a previous transaction with a previously identified remote computer system 120 the identification computer system 110 sent a cookie with a unique identifier to the previously identified remote computer system 120, such a unique identifier may be used to confirm the identification of a particular remote computer system 120 as the previously identified remote computer system 120, or conversely to determine whether the match is a false positive. Using a cookie to confirm identifications may be performed on a subset (e.g. 10%) of identifications to estimate the accuracy of the script-based identification procedure generally.

In various embodiments, time analyzer module 324 receives (e.g., included in result message 134) execution time information 334 related to the amount of time used by remote computer system 120 in executing the scripts of the customized device identification procedure. Such execution time information 334 may include the time taken to execute the entire customized device identification procedure and/or the time taken to execute each individual script. Time analyzer module 324 determines, based on the received execution time information 334, whether the customized device identification procedure took too long to execute. Determining whether the customized device identification procedure took too long to execute may be based on part on the requested transaction (e.g., a customized device identification procedure that took thirty seconds to execute may be too long for a $100 purchase but may not be too long for a file transfer of top secret information). If the customized device identification procedure took too long to execute, effectiveness determiner module 320 may determine to remove one or more scripts from the device identification procedure and/or change one or more scripts in the device identification procedure for other scripts to generate the revised device identification procedure for subsequent identifications. Conversely, if the duration of the execution time of the customized device identification procedure is shorter than necessary, effectiveness determiner module 320 may determine to add additional scripts to gather additional information and increase certainty.

In various embodiments, script/procedure adjuster module 326 is configured to revise a device identification procedure and/or adjust the scripts used in the device identification procedure. As discussed herein, a device identification procedure may be revised because confidence scores associated with performing the device identification procedure are too low, the device identification procedure takes too long to execute, the device identification procedure returns too many false positives, or for other reasons. Accordingly, script/procedure adjuster module 326 may add and/or remove scripts from the device identification procedure for subsequent identifications. Such adjustments may be made to device identification procedures to be used to identify remote computer systems 120 sharing certain characteristics (e.g., running the same operating system, running the same web browser) or to all device identification procedures. Further, script/procedure adjuster module 326 may adjust individual scripts to cause them to gather more, less, or different information from remote computer systems 120.

As discussed herein, in various embodiments, script repository 330 stores a plurality of scripts for the device identification procedure techniques disclosed herein. The scripts may be grouped in predetermined sets of scripts 332 (e.g., a first group of scripts to send to remote computer systems 120 running a first operating system and a first web browser, a second group of scripts to send to remote computer systems running a second operating system and an app distinct from a web browser, etc.). In various embodiments, archive 340 stores one or more previous received sets of results corresponding to previously identified remote computer systems 120. Both script repository 330 and archive 340 may be stored (separately or together) on any suitable memory device or system in various embodiments including a single memory (e.g., a hard drive, solid-state drive, etc.), an array of memories, or a storage computer system.

In operation, identification computer system 110 is configured to receive information (e.g., information included in information message 130) from a remote computer system 120 relating to some general information about remote computer system 120 (e.g., the operating system remote that computer system 120 is running). Based on this general information, identification computer system 110 customizes a device identification procedure containing various scripts executable by remote computer system 120 to gather information usable to specifically identify remote computer system 120. Identification computer system 110 sends an indication (e.g., in indication message 132) of the customized device identification procedure to remote computer system 120. Identification computer system 110 receives from remote computer system 120 the results of the customized device identification procedure, and uses the results to identify remote computer system 120. Identification computer system 110 may also use the results to improve the device identification procedure for subsequent identifications.

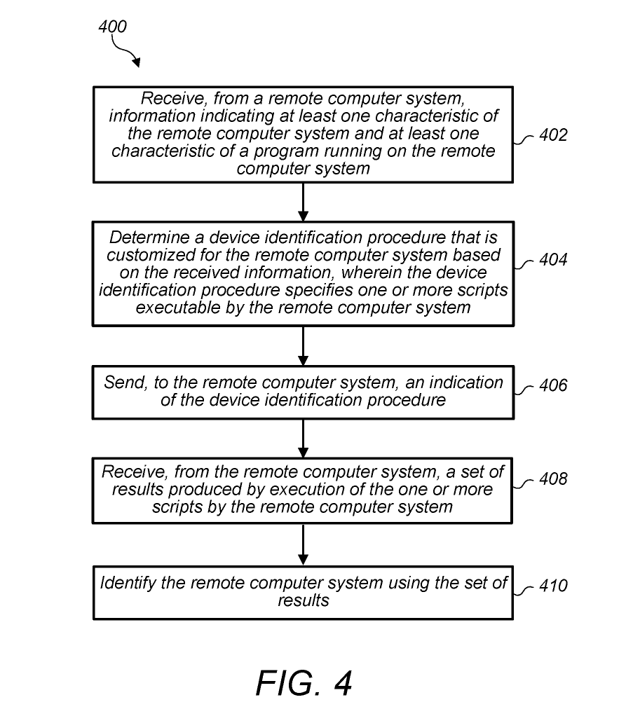

FIGS. 4, 5, 6A, 6B, and 7 illustrate various flowcharts representing various disclosed methods implemented with identification computer system 110 and/or remote computer system 120. Referring now to FIG. 4, a flowchart illustrating a customized device identification method 400 is shown. The various actions associated with method 400 are performed with an identification computer system 110. At block 402, an identification computer system 110 receives, from a remote computer system 120, information indicating at least one of remote computer system 120 and at least one characteristic of a program running on remote computer system 120. At block 404, identification computer system 110 determines device identification procedure that is customized for remote computer system 120 based on the received information, wherein the device identification procedure specifies one or more scripts executable by remote computer system 120. At block 406, identification computer system 110 sends, to remote computer system 120, an indication of the device identification procedure. At block 408, identification computer system 110 receives, from remote computer system 120, a set of results produced by execution of the one or more scripts by remote computer system 120. At block 410, identification computer system 110 identifies remote computer system 120 using the set of results.

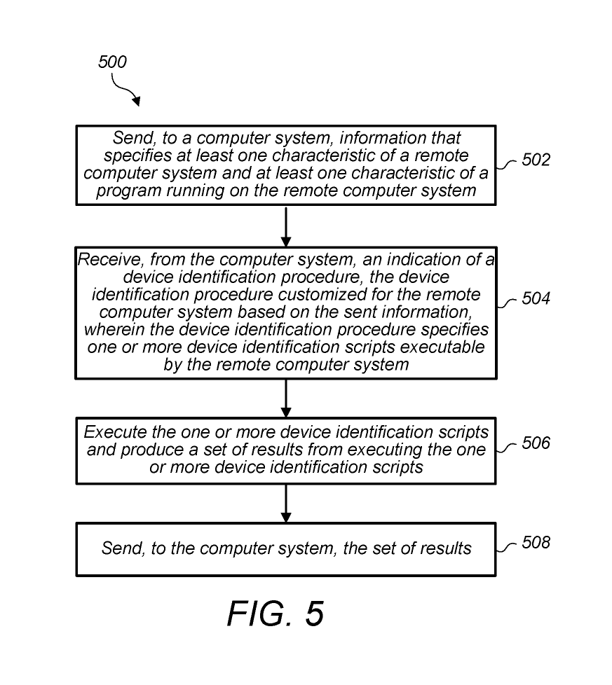

Referring now to FIG. 5, a flowchart illustrating a customized device identification method 500 is shown. The various actions associated with method 500 are performed with a remote computer system 120 (e.g., a user device). At block 502, remote computer system 120 sends, to a computer system (e.g., an identification computer system 110), information that specifies at least one characteristic of remote computer system 120 and at least one characteristic of a program running on remote computer system 120. At block 504, remote computer system 120 receives, from identification computer system 110, an indication of a device identification procedure, the device identification procedure customized for remote computer system 120 based on the sent information. The device identification procedure specifies one or more device identification scripts executable by remote computer system 120. At block 506, remote computer system 120 executes the one or more device identification scripts and produces a set of results from executing the one or more device identification scripts. At block 508, remote computer system 120 sends, to identification computer system 110, the set of results.

Referring now to FIG. 6A, a flowchart illustrating a method 600A to identify a remote computer system 120A running a web browser 200 is shown. The various actions associated with method 600A are performed with a remote computer system 120A as depicted in FIG. 2A and an identification computer system 110. At block 602, remote computer system 120A requests a transaction with identification computer system 110 using a web browser 200 running on remote computer system 120. As part of this request, remote computer system 120A sends an information message 130 including information indicative of characteristics (e.g., at least one characteristic of remote computer system 120A and at least one characteristic of a program running on remote computer system 120A) of remote computer system 120A in transmission 604. At block 606, identification computer system 110 receives transmission 604, collects information message 130, and parses the received information contained therein. At block 608, identification computer system 110 determines a customized device identification procedure for remote computer system 120A and generates a device identification indicator payload (including the scripts that remote computer system 120A is to execute). Identification computer system 110 sends the device indication indicator payload as indicator message 132 in transmission 610. At block 612, remote computer system 120A receive the device identification indicator (e.g., indication message 132) with script(s) remote computer system 120A is to run. Remote computer system 120A runs the script(s) with web browser 200 and stores the results. At block 614, remote computer system 120A assembles a package of results with timing information for execution of the scripts (e.g., results message 134). Remote computer system 120A sends the results message 134 to identification computer system 110 in transmission 616. At block 618, identification computer system 110 receives the results and timing information, and based on the results and timing information identifies remote computer system 120A. Alternatively, identification computer system 110 may fail to identify remote computer system 120A or may inconclusively identify remote computer system 120A (not shown). In either case, identification computer system 110 may request additional information from remote computer system. At block 620, identification computer system 110, in some embodiments, determines the effectiveness of the device identification procedure, and based on such determination adjusts the device identification procedure (and/or its constituent scripts) for subsequent identifications. Based on the identification (or failure to identify) of remote computer system 120A, identification computer system 110 determines whether to execute the requested transaction with remote computer system 120A.

Referring now to FIG. 6B, a flowchart illustrating a method 600B to identify a remote computer system 120B running an application 240 is shown. The various actions associated with method 600B are performed with a remote computer system 120B as depicted in FIG. 2B and an identification computer system 110. Most of the various actions in method 600B are similar to actions in method 600A discussed herein in relation to FIG. 6A. At block 622, remote computer system 120B installs application 240, which includes an app ID and various device identification scripts 242. At block 602, remote computer system 120B requests a transaction with identification computer system 110 using application 240 running on remote computer system 120B. As part of this request, remote computer system 120B sends an information message 130 including information indicative of characteristics (e.g., type of operating system 210, information about application 240) of remote computer system 120BB in transmission 604. At block 606, identification computer system 110 receives transmission 604, collects information message 130, and parses the information contained therein. At block 608, identification computer system 110 determines a customized device identification procedure for remote computer system 120B and generates a device identification indicator payload (including indicators of the scripts remote computer system 120B is to execute but not the scripts themselves). Identification computer system 110 sends the device indication indicator payload as indicator message 132 in transmission 610. At block 612, remote computer system 120B receive the device identification indicator (e.g., indication message 132) with indicators of the script(s) remote computer system 120B is to run. Remote computer system 120B runs the stored device identification script(s) as directed in indicator message 132 and stores the results. At block 614, remote computer system 120B assembles a package of results with timing information for execution of the scripts (e.g., results message 134). Remote computer system 120B sends results message 134 to identification computer system 110 in transmission 616. At block 618, identification computer system 110 receives the results and timing information, and based on the results and timing information identifies remote computer system 120B. Alternatively, identification computer system 110 may fail to identify remote computer system 120B or may inconclusively identify remote computer system 120B (not shown). In either case, identification computer system 110 may request additional information from remote computer system (not shown). At block 620, identification computer system 110, in some embodiments, determines the effectiveness of the device identification procedure, and based on such determination adjusts the device identification procedure (and/or its constituent scripts) for subsequent identifications. Based on the identification (or failure to identify) of remote computer system 120B, identification computer system 110 determines whether to execute the requested transaction with remote computer system 120B.

Referring now to FIG. 7, a flowchart illustrating additional detail of the actions performed at blocks 606 and 608 of FIGS. 6A and 6B is shown. The various actions associated with blocks 606 and 608 are performed with an identification computer system 110. At block 700, identification computer system 110 determines, based on the received information message 130, whether information message 130 corresponds to a web browser 200 or application 240.

If information message 130 corresponds to a web browser 200, at block 702, identification computer system 110 parses information message 130 for indicators of characteristics of remote computer system 120 and web browser 200. At block 704, identification computer system 110 determines operating system 210 and web browser 200 of remote computer system 120. At block 706, identification computer system 110 determines additional information to collect, and generates a device identification procedure to collect additional information from remote computer system 120. At block 708, identification computer system 110 determines one or more device identification script(s) to request remote computer system to perform as part of the device identification procedure. Identification computer system 110 package script(s) to send to remote computer system 120.

If information message 130 corresponds to an application 240, at block 710, identification computer system 110 parses information message 130 for indicators of characteristics of remote computer system 120 and application 240. At block 712, identification computer system 110 determines operating system 210 and application 240 of remote computer system 120. At block 714, identification computer system 110 determines additional information to collect, and generates a device identification procedure to collect additional information from remote computer system 120. At block 717, identification computer system 110 determines one or more device identification script(s) to request remote computer system to perform as part of the device identification procedure. Identification computer system 110 packages indicator(s) script(s) to send to remote computer system 120.

Referring now to FIG. 8, an exemplary table 800 showing example sets of scripts to include in a customized device identification procedure for various configurations of remote computer system 120 as determined by parsing an information message 130. Looking at row 802, if remote computer system 120 is an Apple iPhone® runs the iOS® operating system and Safari® web browser, the customized device identification procedure may include scripts to determine the IP address of remote computer system 120, determine hardware information about a screen of remote computer system 120, and have remote computer system 120 perform canvas fingerprinting test and hash the result. The canvas fingerprinting test may be one of a number of browser fingerprinting techniques that allow websites to identify and track visitors using HTML5 canvas elements.

Looking at row 804, if remote computer system 120 is an Apple Mac® computer runs the macOS® operating system and Safari® web browser, the customized device identification procedure may include scripts to determine the IP address of remote computer system 120, determine hardware information about a screen of remote computer system 120, and determine the fonts installed on remote computer system 120. Looking at row 806, if remote computer system 120 runs the Microsoft Windows® NT operating system and Internet Explorer® web browser, the customized device identification procedure may include scripts to determine the IP address of remote computer system 120, determine hardware information about a screen of remote computer system 120, determine the fonts installed on remote computer system 120, and determine the plug-ins installed on web browser 200. Looking at row 808, if remote computer system 120 runs the Google Android® operating system and Chrome® web browser, the customized device identification procedure may include scripts to determine the IP address of remote computer system 120 and have remote computer system 120 perform canvas fingerprinting test and hash the result. Looking at row 810, if remote computer system 120 runs the Google Android® operating system and an application 240 having a certain version, the customized device identification procedure may include scripts to determine an Android ID of the Google Android® operating system, an app ID of the application 240, a latitude of remote computer system 120, and a longitude of remote computer system 120. The customized device identification procedure used to identify various remote computer systems 120 may differ from those shown in FIG. 8, however, and may include additional scripts to gather information about remote computer system 120.

### Exemplary Computer System

Turning now to FIG. 9, a block diagram of an exemplary computer system 900, which may implement the various components of identification computer system 110 and remote computer system 120, is depicted. Computer system 900 includes a processor subsystem 980 that is coupled to a system memory 920 and I/O interfaces(s) 940 via an interconnect 960 (e.g., a system bus). I/O interface(s) 940 is coupled to one or more I/O devices 950. Computer system 900 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 900 is shown in FIG. 9 for convenience, system 900 may also be implemented as two or more computer systems operating together.

Processor subsystem 980 may include one or more processors or processing units. In various embodiments of computer system 900, multiple instances of processor subsystem 980 may be coupled to interconnect 960. In various embodiments, processor subsystem 980 (or each processor unit within 980) may contain a cache or other form of on-board memory. In remote computer system 120, processor subsystem 980 includes processor circuit 124.

System memory 920 is usable store program instructions executable by processor subsystem 980 to cause system 900 perform various operations described herein. System memory 920 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 900 is not limited to primary storage such as memory 920. Rather, computer system 900 may also include other forms of storage such as cache memory in processor subsystem 980 and secondary storage on I/O Devices 950 (e.g., a hard drive, storage array, etc.). In some embodiments, these other forms of storage may also store program instructions executable by processor subsystem 980.

I/O interfaces 940 may be any of various types of interfaces configured to couple to and communicate with other devices, according to various embodiments. In one embodiment, I/O interface 940 is a bridge chip (e.g., Southbridge) from a front-side to one or more back-side buses. I/O interfaces 940 may be coupled to one or more I/O devices 950 via one or more corresponding buses or other interfaces. Examples of I/O devices 950 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 900 is coupled to a network via a network interface device 950 (e.g., configured to communicate over WiFi, Bluetooth, Ethernet, etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory, computer-readable medium storing instructions that, when executed by a computer system, cause the computer system to perform operations comprising:
receiving, from a remote computer system that is running a program, information that specifies at least one characteristic of the remote computer system and at least one characteristic of the program;
determining a device identification procedure that is customized for the remote computer system based on the received information, wherein the device identification procedure specifies one or more scripts executable by the remote computer system;
sending, to the remote computer system, an indication of the device identification procedure;
receiving, from the remote computer system, a set of results produced by execution of the one or more scripts by the remote computer system; and
identifying, using the set of results, the remote computer system.

2. The computer-readable medium of claim 1, wherein the program is a web browser.

3. The computer-readable medium of claim 2, wherein the information comprises user agent information, and wherein the user agent information specifies a particular operating system running on the remote computer system and a particular web browser running on the remote computer system.

4. The computer-readable medium of claim 3, the operations further comprising:
storing, at the computer system, a first set of scripts associated with the particular operating system and the particular web browser;
wherein the device identification procedure that is customized for the remote computer system specifies the first set of scripts.

5. The computer-readable medium of claim 1, wherein the indication of the device identification procedure includes the one or more scripts, and wherein the sending includes sending the one or more scripts to the remote computer system.

6. The computer-readable medium of claim 1, wherein the indication of the device identification procedure includes script information specifying the one or more scripts, and wherein the sending includes sending the script information but not the one or more scripts to the remote computer system.

7. The computer-readable medium of claim 1, wherein the identifying includes:
comparing the set of results to data indicative of previously identified remote computer systems; and
identifying the remote computer system based on the comparing.

8. The computer-readable medium of claim 7, wherein the identifying includes:
based on the comparing, making a determination that the remote computer system is on a blacklist; and
based on the determination, rejecting a transaction request from the remote computer system.

9. The computer-readable medium of claim 7, wherein the identifying includes:
based on the comparing, making a determination that the remote computer system is on a list of approved remote computer systems; and
based on the determination, accepting a transaction request from the remote computer system.

10. The computer-readable medium of claim 7, the operations further comprising:
based on set of results and the comparing, generating a revised device identification procedure that is available for subsequent identifications;
wherein the one or more scripts specified by the device identification procedure are not identical to the one or more scripts specified by the revised device identification procedure.

11. A method comprising:
receiving, at a computer system and from a remote computer system, information indicating at least one characteristic of the remote computer system and at least one characteristic of a program running on the remote computer system;
determining, with the computer system, a device identification procedure that is customized for the remote computer system based on the received information, wherein the device identification procedure specifies one or more scripts executable by the remote computer system;
sending, from the computer system to the remote computer system, an indication of the device identification procedure;
receiving, at the computer system and from the remote computer system, a set of results produced by execution of the one or more scripts by the remote computer system; and
identifying, at the computer system, the remote computer system using the set of results.

12. The method of claim 11, wherein the remote computer system is a mobile device, and wherein the program is a mobile application, and wherein the mobile application is distinct from mobile browser programs installed on the mobile device.

13. The method of claim 12, wherein the received information specifies the operating system of the mobile device and the mobile application.

14. The method of claim 11, wherein the set of results include information produced by executing the scripts and information about the execution time of the one or more scripts.

15. The method of claim 11, further comprising:
receiving, at the computer system, a request from the remote computer system to execute a transaction; and
based on the identifying, determining, with the computer system, whether to execute the requested transaction with the remote computer system.

16. The method of claim 11, further comprising:
storing, at the computer system, a set of device identification scripts that when executed by a remote computer system having a particular characteristic and running a particular program will produce a set of anticipated results, the set of anticipated results being predicted to differentiate a particular remote computer system having the particular characteristic and running the particular program from another remote computer system having the particular characteristic and running the particular program; and
wherein the received information indicates that the remote computer system has the particular characteristic and is running the particular program, and wherein determining the device identification procedure includes determining to specify the set of device identification scripts with the device identification procedure.

17. The method of claim 16, further comprising:
based on the identifying, determining, with the computer system, an effectiveness of the set of device identification scripts in differentiating between the remote computer system having the particular characteristic and running the particular program from another remote computer system having the particular characteristic and running the particular program; and
based on the effectiveness determination, changing the set of device identification scripts.

18. A method comprising:
sending, from a remote computer system to a computer system, information that specifies at least one characteristic of the remote computer system and at least one characteristic of a program running on the remote computer system;
receiving, at the remote computer system from the computer system, an indication of a device identification procedure, the device identification procedure customized for the remote computer system based on the sent information, wherein the device identification procedure specifies one or more device identification scripts executable by the remote computer system;
executing, at the remote computer system, the one or more device identification scripts and producing a set of results from executing the one or more device identification scripts; and
sending, from the remote computer system to the computer system, the set of results.

19. The method of claim 18, further comprising:
storing, at the remote computer system, a plurality of device identification scripts; and
wherein the indication of the device identification procedure includes script information specifying one or more device identification scripts of the plurality of device identification scripts, and wherein the receiving includes receiving the script information but not the one or more device identification scripts.

20. The method of claim 18, wherein the indication of the device identification procedure includes the one or more device identification scripts, and wherein the executing includes executing the one or more device identification scripts received from the computer system.
